(19) United States
(12) Patent Application Publication
(10) Pub. No.: US 2020/0095440 A1
(43) Pub. Date: Mar. 26, 2020

(54) INKJET AQUEOUS INK COMPOSITION

(71) Applicant: MIMAKI ENGINEERING CO., LTD., Nagano (JP)

(72) Inventors: Masanobu Shinohara, Nagano (JP); Hitomi Narumiya, Nagano (JP)

(73) Assignee: MIMAKI ENGINEERING CO., LTD., Nagano (JP)

(21) Appl. No.: 16/579,849

(22) Filed: Sep. 24, 2019

(30) Foreign Application Priority Data
Sep. 25, 2018 (JP) 2018-178701

(51) Int. Cl. C09D 11/30; C08L 33/08; C08K 5/3415; C08K 5/3445; C08K 5/357; C08K 5/06; C08K 5/05

(52) U.S. Cl. CPC C09D 11/30; C08L 33/08; C08K 5/3415; C08K 5/05; C08K 5/357; C08K 5/06; C08K 5/3445

(57) ABSTRACT

An inkjet aqueous ink composition comprises a heterocyclic compound having a nitrogen atom in the heterocycle and a carbonyl group adjacent to the nitrogen atom, a resin, and water. The heterocyclic compound is preferably selected from the group consisting of 1,3-dimethyl-2-imidazolidinone and 1-methyl-2-pyrrolidone. The resin is preferably an acrylic resin.

### CROSS-REFERENCE TO RELATED APPLICATION

This application claims the priority benefit of Japan application serial no. 2018-178701, filed on Sep. 25, 2018. The entirety of the above-mentioned patent application is hereby incorporated by reference herein and made a part of this specification.

### BACKGROUND OF THE INVENTION

### Technical Field

The present invention relates to an inkjet aqueous ink composition.

### Background Art

Solvent inks, UV curable inks, aqueous inks and the like have been developed for inkjet printing onto vinyl chloride and other media with low ink absorbency (hereinafter referred to as low-absorbent media). Among these inks, there is a particular focus on aqueous inks from the viewpoint of the environmental burden.

Patent Literature 1, for example, discloses an aqueous ink comprising polyester based resin particles containing a pigment, polyester based resin particles not containing a pigment, an organic solvent, and water. In this inkjet ink, ethers, alcohols, esters, lactones, lactams, amines or the like are used as the organic solvent.

Patent Literature 1 Japanese Unexamined Patent Publication No. 2017-226834

### SUMMARY

However, a low-absorbent medium has a particularly low capacity to absorb, out of the various inks, an aqueous ink. Accordingly, when a general inkjet water-based ink, e.g., a water-based pigment ink, is used in inkjet printing onto a low-absorbent medium, image bleeding and clumping may be produced due to the low penetrability of the water-based ink into the low-absorbent medium. Because of the low penetrability of the water-based ink into the low-absorbent medium, the scratch resistance of printed matter may be lower. It is therefore difficult to print suitably onto a vinyl chloride medium with a conventional aqueous ink.

The present invention provides an inkjet aqueous ink composition that can be suitably printed onto a vinyl chloride medium.

As a result of an assiduous investigation to solve the problem, the present inventors found that it is possible to manufacture an ink that can be printed onto a vinyl chloride medium by blending a heterocyclic compound into an inkjet aqueous ink. The present inventors continued the investigation which led to the completion of the present invention.

The inkjet aqueous ink composition of a first aspect of the present invention comprises a heterocyclic compound having a nitrogen atom in the heterocycle and a carbonyl group adjacent to the nitrogen atom, a resin, and water.

The ink thus configured can be suitably printed onto a vinyl chloride medium.

The heterocyclic compound is preferably selected from the group consisting of 1,3-dimethyl-2-imidazolidinone and 1-methyl-2-pyrrolidone.

The ink thus configured can be suitably printed onto a vinyl chloride medium.

The resin is preferably an acrylic resin.

The ink thus configured can be suitably printed onto a vinyl chloride medium. The ink has excellent ethanol resistance when printed onto a vinyl chloride medium and a favorable nozzle clogging rate during printing.

Preferably, the inkjet aqueous ink composition further comprises a solvent having a moisturizing effect.

The ink thus configured can be suitably printed onto a vinyl chloride medium. The ink has a favorable nozzle clogging rate during printing.

The solvent having a moisturizing effect is preferably a diol organic solvent.

The ink thus configured can be suitably printed onto a vinyl chloride medium. The ink has a favorable nozzle clogging rate during printing.

Preferably, the inkjet aqueous ink composition further comprises an organic solvent with a boiling point of 250° C. or less.

The ink thus configured can be suitably printed onto a vinyl chloride medium. The ink has excellent ethanol resistance when printed onto a vinyl chloride medium. By using the ink, the dot diameter during printing can be made relatively large. Thus the ink is suitable for printing clear images with small intervals between the dots.

The organic solvent with a boiling point of 250° C. or less is preferably a glycol ether organic solvent.

The ink thus configured can be suitably printed onto a vinyl chloride medium. The ink has excellent ethanol resistance when printed onto a vinyl chloride medium. By using the ink, the dot diameter during printing can be made relatively large. Thus the ink is suitable for printing clear images with small intervals between the dots.

The inkjet aqueous ink composition of the present invention can be suitably printed onto a vinyl chloride medium.

### DESCRIPTION OF EMBODIMENTS

The inkjet aqueous ink composition of the present invention comprises a heterocyclic compound having a nitrogen atom in the heterocycle and a carbonyl group adjacent to the nitrogen atom, a resin, and water.

(Heterocyclic Compound)

Any heterocyclic compound may be used as long as the heterocyclic compound has a nitrogen atom in the heterocycle and a carbonyl group adjacent to the nitrogen atom.

Examples of such a heterocyclic compound include N-acylmorpholine, an imidazolidinone compound, and a pyrrolidone compound.

Examples of the N-acylmorpholine include compounds represented by formula (I).

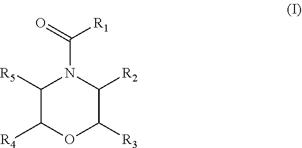

(In the formula, R₁ is H or an alkyl group having 1 to 18 C atoms, and R₂, R₃, R₄, and R₅ are each, independently of one another, H or a (cyclo)alkyl group of 1 to 18 C atoms.)

R₁ is optionally selected from the group consisting of H, methyl, and ethyl.

R₂, R₃, R₄, and R₅ are each, independently of one another, optionally selected from the group consisting of H, methyl, ethyl, isopropyl, and cyclohexyl.

In particular, examples of the N-acylmorpholine include N-formylmorpholine, N-acetylmorpholine, and N-propionylmorpholine.

Examples of the imidazolidinone compound include compounds represented by formula (II).

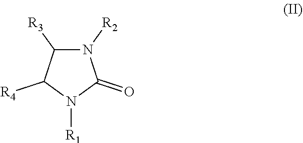

(In the formula, R₁ and R₂ are each, independently of one another, H, an alkyl group having 1 to 18 C atoms, a hydroxyalkyl group, or an acyl group, and R₃ and R₄ are each, independently of one another, H or a (cyclo)alkyl group of 1 to 18 C atoms.)

R₁ and R₂ are each, independently of one another, optionally selected from the group consisting of H, methyl, and ethyl.

R₃ and R₄ are optionally selected from the group consisting of H, methyl, ethyl, isopropyl, and cyclohexyl.

In particular, examples of the imidazolidinone compound include 2-imidazolidinone, 1,3-dimethyl-2-imidazolidinone, 1-(2-hydroxyethyl)-2-imidazolidinone, and 1-acetyl-2-imidazolidinone. These compounds may be used alone or two or more may be used in combination.

Examples of the pyrrolidone compound include compounds represented by formula (III).

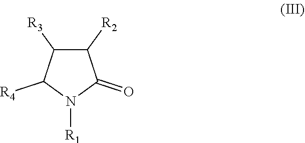

(In the formula, R₁ is H, an alkyl group having 1 to 18 C atoms, a hydroxyalkyl group, or an acyl group, and

R_{2,} R₃ and R₄ are each, independently of one another, H or a (cyclo)alkyl group of 1 to 18 C atoms.)

R₁ is optionally selected from the group consisting of H, methyl, and ethyl.

R₂, R₃, and R₄ are each, independently of one another, optionally selected from the group consisting of H, methyl, ethyl, isopropyl, and cyclohexyl.

In particular, examples of the pyrrolidone compound include 2-pyrrolidone, 1-methyl-2-pyrrolidone, 1-ethyl-2-pyrrolidone, 5-methyl-2-pyrrolidone, 1-acetyl-2-pyrrolidone, 1-butyl-2-pyrrolidone, and 4,4-pentamethylene-2-pyrrolidone. These compounds may be used alone or two or more may be used in combination.

The blending amount of the heterocyclic compound is not particularly limited but is preferably 1 to 50 mass % in the ink composition, more preferably 5 to 40 mass %, and particularly preferably approximately 10 mass %.

If the blending amount of the heterocyclic compound is greater than 10 mass % in the ink composition, the solvent having a moisturizing effect described below is preferably blended in the ink composition from the viewpoint of ink ejection.

(Resin)

The resin in the present invention is not particularly limited but examples include an acrylic based resin, a polyester based resin, a polyurethane based resin, a vinyl chloride based resin, a nitrocellulose, and a vinyl chloride-vinyl acetate copolymer resin. Among these, the acrylic based resin, the polyester based resin, and the vinyl chloride-vinyl acetate copolymer resin are preferable and the acrylic based resin is more preferable from a viewpoint of ink ejection and scratch resistance.

The blending amount of the resin is not particularly limited but is preferably 0.1 to 50 mass % in the ink composition, more preferably 0.5 to 40 mass %, and particularly preferably 1 to 25 mass %.

(Solvent Having a Moisturizing Effect)

A solvent having a moisturizing effect is optionally further blended in the ink composition. Blending such a solvent can be expected to result in the favorable ejection of the ink composition (e.g., a nozzle clogging rate that is relatively low and preferably substantially null).

Such a solvent with a moisturizing effect is not particularly limited but is preferably a diol organic solvent. The boiling point of the solvent having a moisturizing effect is preferably 250° C. or less. If the boiling point of the solvent with a moisturizing effect exceeds 250° C., there are the risks that the solvent with a moisturizing effect will remain, even after drying, in the ink coating film and that the ethanol resistance of the printed matter will degrade.

Examples of the diol organic solvent include ethylene glycol, diethylene glycol, propylene glycol, dipropylene glycol, 1,5-pentanediol, 2-methyl-2,4-pentanediol, hexylene glycol, 1,2-butanediol, 1,3-butanediol, 3-methyl-1,3-butanediol, 1,2-pentanediol, 1,5-pentanediol, and 1,2-hexanediol. These compounds may be used alone or two or more may be used in combination.

(Organic Solvent With a Boiling Point of 250° C. or Less)

An organic solvent with a boiling point of 250° C. or less is optionally blended in the ink composition. With blending such a solvent, an improvement in the ethanol resistance can be expected. If the boiling point of the organic solvent exceeds 250° C., there are the risks that the solvent will remain, even after drying, in the ink coating film and that the ethanol resistance of the printed matter will degrade.

Such an organic solvent with a boiling point of 250° C. or less is not particularly limited but is preferably a glycol ether organic solvent. Blending the glycol ether organic solvent reduces the surface tension of the ink, and increases the dot diameter formed when printing with the ink composition so as to be larger than the case where the glycol ether organic solvent is not blended.

Examples of the glycol ether organic solvent include dipropylene glycol monomethyl ether (boiling point: 188° C.), dipropylene glycol monopropyl ether (boiling point: 210° C.), dipropylene glycol monobutyl ether (boiling point: 230° C.), diethylene glycol monomethyl ether (boiling point: 193° C.), diethylene glycol monoethyl ether (boiling point: 196° C.), diethylene glycol monobutyl ether (boiling point: 230° C.), triethylene glycol monomethyl ether (boiling point: 248° C.), propylene glycol monomethyl ether (boiling point: 121° C.), propylene glycol monoethyl ether (boiling point: 133° C.), propylene glycol monopropyl ether (boiling point: 149° C.), propylene glycol monobutyl ether (boiling point: 170° C.), propylene glycol monophenyl ether (boiling point: 244° C.), ethylene glycol monomethyl ether (boiling point: 124° C.), ethylene glycol monoethyl ether (boiling point: 135° C.), ethylene glycol monopropyl ether (boiling point: 151° C.), ethylene glycol monobutyl ether (boiling point: 171° C.), ethylene glycol monophenyl ether (boiling point: 237° C.), ethylene glycol monohexyl ether (boiling point: 205° C.), ethylene glycol mono-2-ethylhexyl ether (boiling point: 229° C.), ethylene glycol diethyl ether (boiling point: 121° C.), diethylene glycol dimethyl ether (boiling point: 162° C.), diethylene glycol ethyl methyl ether (boiling point: 179° C.), diethylene glycol diethyl ether (boiling point: 188° C.), dipropylene glycol dimethyl ether (boiling point: 171° C.), ethylene glycol monoethyl ether acetate (boiling point: 156° C.), ethylene glycol monobutyl ether acetate (boiling point: 192° C.), propylene glycol methyl ether acetate (boiling point: 146° C.), diethylene glycol monoethyl ether acetate (boiling point: 218° C.), and diethylene glycol monobutyl ether acetate (boiling point: 247° C.), and dipropylene glycol monopropyl ether is particularly preferable. These compounds may be used alone or two or more may be used in combination.

The blending amount of the organic solvent with a boiling point of 250° C. or less is not particularly limited but is preferably 0.1 to 40 mass % in the ink composition, more preferably 1 to 30 mass % and particularly preferably 5 to 30 mass %.

(Surface Tension Reducing Component)

A surface tension reducing component for reducing the surface tension of the ink may be blended into the ink composition. Blending such a component increases the dot diameter formed by the ink composition during printing compared to the case where such a component is not blended.

Any surface tension reducing component that reduces the surface tension of the ink, e.g., a surfactant, may be used.

Examples of the surfactant include an anionic surfactant (e.g., sodium dodecylbenzenesulfonate, sodium laurate, and an ammonium salt of polyoxyethylene alkyl ether sulfate), a nonionic surfactant (e.g., polyoxyethylene alkyl ether, polyoxyethylene alkyl ester, polyoxyethylene sorbitan fatty acid ester, polyoxyethylene alkyl phenyl ether, polyoxyethylene alkyl amine, and polyoxyethylene alkyl amide), an acetylenic glycol surfactant (e.g., Orfin Y, Orfin STG, and Surfynol 82, 104, 440, 465, and 485, all manufactured by Air Products and Chemicals Inc.), and a silicone surfactant (BYK-306, BYK-307, BYK-333, BYK-341, BYK-345,

File: 90347usf BYK-346, BYK-348, and BYK-349, all manufactured by BYK Japan KK). These compounds may be used alone or two or more may be used in combination.

The blending amount of the surfactant is not particularly limited but is preferably 0.01 to 5 mass % in the ink composition, more preferably 0.05 to 3 mass %, and particularly preferably 0.1 to 1 mass %.

(Other Components)

The aqueous ink composition of the present invention optionally contains other components within a scope that does not impair the invention. Examples of the other components include a colorant, a dispersant, a plasticizer, a surface conditioner, a leveling agent, a defoaming agent, an antioxidant, a charge-imparting agent, a germicide, an antiseptic, a deodorant, a charge control agent, a wetting agent, an anti-skinning agent, a perfume, and a pigment derivative.

The aqueous ink composition of the present invention optionally contains a colorant if the aqueous ink composition is a colored ink. A known dye or pigment may be used as the colorant. Among these, a pigment is preferable and examples thereof include an inorganic pigment and an organic pigment.

Examples of the inorganic pigment include titanium oxide, zinc oxide, tripon, iron oxide, aluminum oxide, silicon dioxide, kaolinite, montmorillonite, talc, barium sulfate, calcium carbonate, silica, aluminum oxide, cadmium red, red iron oxide, molybdenum red, chrome vermilion, molybdate orange, chrome yellow, cadmium yellow, yellow iron oxide, titan yellow, chromium oxide, viridian, cobalt green, titan cobalt green, cobalt chrome green, ultramarine blue, iron blue, cobalt blue, cerulean blue, manganese violet, cobalt violet, and mica.

Examples of the organic pigment include azo, azomethine, polyazo, phthalocyanine, quinacridone, anthraquinone, indigo, thioindigo, quinophthalone, benzimidazolone, isoindolin, and isoindolinone pigments and carbon black.

If the aqueous ink composition of the present invention is a cyan ink, Heliogen Blue manufactured by BASF Japan Ltd.; C.I. pigment blue 1, 2, 3, 15:3, 15:4, 15:34, 16, 22, or 60; or the like may be blended as the colorant.

If the aqueous ink composition of the present invention is a magenta ink, C.I. pigment red 5, 7, 12, 48(Ca), 48(Mn), 57(Ca), 57:1, 112, 122, 123, 168, 184, 202, or 209; C.I. pigment violet 19; or the like may be blended as the colorant.

If the aqueous ink composition of the present invention is a yellow ink, C.I. pigment yellow 1, 2, 3, 12, 13, 14C, 16, 17, 73, 74, 75, 83, 93, 95, 97, 98, 109, 110, 114, 120, 128, 129, 130, 138, 150, 151, 154, 155, 180, 185, or the like may be blended as the colorant.

If the aqueous ink composition of the present invention is a black ink, HiBlack890 manufactured by Orion Engineered Carbons; HCF, MCF, RCF, LFF, or SCF manufactured by Mitsubishi Chemical Corporation; Monarch or Regal manufactured by Cabot Corporation; Color Black, Special Black, or Printex manufactured by Degussa-Hüls AG; TOKABLACK manufactured by Tokai Carbon Co., Ltd.; Raven manufactured by Columbia; or the like may be blended.

The content of the colorant in the aqueous ink composition of the present invention is not particularly limited but is preferably 1 to 20 parts by weight and more preferably 1 to 10 parts by weight to 100 parts by weight of the total amount of the ink composition.

If a pigment is used as the colorant, a dispersant may be used in the aqueous ink composition in order to disperse the pigment. A dispersant is not needed if a self-dispersing pigment such as a microencapsulated pigment is used.

Examples of the dispersant include a low-molecular dispersant and a high-molecular dispersant. More specifically, the examples include nonionic, cationic, and anionic surfactants, a polyester high-molecular dispersant, an acrylic high-molecular dispersant, and a polyurethane high-molecular dispersant.

Examples of the dispersant that are commercially available include pigment dispersants (Solsperse 44000, 74000, 82500, 83500, V350, W200, WV 400, J180, and 39000) manufactured by Lubrizol Japan Limited and high-molecular pigment dispersants (AJISPER PB821, PB822, PB824, PB881, PN411, and PA111) manufactured by Ajinomoto Fine-Techno Co., Ltd.

The aqueous ink composition of the present invention is not limited by the method of manufacturing it but may be prepared, for example, by mixing the colorant, the organic solvent, and other components as needed, and mixing and dispersing with a disperser.

Examples of the disperser include a Three-One Motor, a magnetic stirrer, a Disper, a homogenizer, a ball mill, a centrifugal mill, a container driving medium mill such as a planetary ball mill, a high-speed mill such as a sand mill, a medium stirring mill such as an agitation tank mill, a bead mill, a high-pressure jet mill, and a Disper.

### EXAMPLES

(Ink components)

The following materials were used in preparation of the ink:
1. Pigment components

A carbon black dispersion liquid (preparation method will be described below)

A cyan dispersion liquid (preparation method will be described below)
2. Resin components

Acrylic resin (Mowinyl 6969D, solid concentration: 41.8%, manufactured by Japan Coating Resin Co., Ltd.)

Urethane resin (Takelac WS-5000, solid concentration: 29.9%, manufactured by Mitsui Chemicals, Inc.)
3. Solvents
(Solvents that are not heterocyclic compounds)

Propylene glycol

Dipropylene glycol monopropyl ether

Glycerol
(Heterocyclic compounds)

N-formylmorpholine

1,3-dimethyl-2-imidazolidinone

1-methyl-2-pyrrolidone
4. Surfactants

Surfactant (BYK-349, manufactured by BYK)
5. Water

Ion-exchanged water

(Preparation of the Carbon Black Dispersion Liquid)

225 g of HiBlack890 (manufactured by Orion Engineered Carbons), 180 g of Solsperse 44000 (manufactured by The Lubrizol Corporation), 15 g of 1,2-hexanediol, and 1080 g of water were mixed and a bead mill used for dispersion to obtain a carbon black dispersion liquid.

(Preparation of the Cyan Dispersion Liquid)

225 g of Heliogen Blue D7088 (manufactured by BASF Japan Ltd.), 180 g of Solsperse 44000 (manufactured by The Lubrizol Corporation), 15 g of 1,2-hexanediol, and 1080 g of water were mixed and a bead mill was used for dispersion to obtain a cyan dispersion liquid.

(Preparation of the Ink)

23 parts by weight of the carbon black dispersion liquid, 21.5 parts by weight of the acrylic resin, 17.5 parts by weight of the propylene glycol, 10.0 parts by weight of the dipropylene glycol monopropyl ether, 10.0 of the N-formylmorpholine, 0.7 parts by weight of the surfactant, and 17.3 parts by weight of the water were adequately mixed with a Three-One Motor to obtain an ink 1. The components and additives were altered as described in Table 1 to obtain, in a similar manner, inks 2 to 18.

TABLE 1

| | Pigment | | | | Solvent | | | | | | | |
|---|---|---|---|---|---|---|---|---|---|---|---|---|
| | Carbon | Cyan | Resin | | | Dipropylene | | Heterocyclic compound | | | | |
| | black | dis- | Acrylic | Urethane | | glycol | | | 1,3-dimethyl- | | Sur- | |
| | dispersion | persion | resin | resin | Propylene | monopropyl | Glyc- | N-formyl- | 2-imidaz- | 1-methyl-2- | fac- | Wa- |
| | liquid | liquid | solution¹ | solution² | glycol | ether | erol | morpholine | olidinone | pyrrolidone | tant | ter |
| Ink 1 | 23.0 | — | 21.5 | — | 17.5 | 10.0 | — | 10.0 | — | — | 0.7 | 17.3 |
| Ink 2 | 23.0 | — | 21.5 | — | 17.5 | 10.0 | — | — | — | — | 0.7 | 27.3 |
| Ink 3 | 23.0 | — | 21.5 | — | 17.5 | — | — | 10.0 | — | — | 0.7 | 27.3 |
| Ink 4 | 23.0 | — | — | 30.1 | 17.5 | 10.0 | — | 10.0 | — | — | 0.7 | 8.7 |
| Ink 5 | — | 10.9 | 21.5 | — | 17.5 | 10.0 | — | 10.0 | — | — | 0.7 | 29.4 |
| Ink 6 | — | 10.9 | 21.5 | — | 23.0 | 10.0 | — | 5.0 | — | — | 0.7 | 28.9 |
| Ink 7 | — | 10.9 | 21.5 | — | 23.0 | 10.0 | — | — | — | — | 0.7 | 33.9 |
| Ink 8 | — | 10.9 | 21.5 | — | 33.0 | — | — | 10.0 | — | — | 0.7 | 23.9 |
| Ink 9 | — | 10.9 | 21.5 | — | 30.0 | — | — | 20.0 | — | — | 0.7 | 16.9 |
| Ink 10 | — | 10.9 | 21.5 | — | 15.0 | — | — | 30.0 | — | — | 0.7 | 21.9 |
| Ink 11 | — | 10.9 | 21.5 | — | 10.0 | — | — | 50.0 | — | — | 0.7 | 6.9 |
| Ink 12 | — | 10.9 | 21.5 | — | — | — | — | 30.0 | — | — | 0.7 | 36.9 |
| Ink 13 | — | 10.9 | 21.5 | — | — | — | 10.0 | 10.0 | — | — | 0.7 | 46.9 |
| Ink 14 | 23.0 | — | 21.5 | — | 17.5 | 10.0 | — | — | 10.0 | — | 0.7 | 27.3 |
| Ink 15 | — | 10.9 | 21.5 | — | 17.5 | 10.0 | — | — | — | 10.0 | 0.7 | 29.4 |
| Ink 16 | — | 10.9 | 21.5 | — | 23.0 | 10.0 | — | — | — | 5.0 | 0.7 | 28.9 |
| Ink 17 | — | 10.9 | 21.5 | — | 10.0 | — | — | — | — | 50.0 | 0.7 | 6.9 |
| Ink 18 | — | 10.9 | 21.5 | — | — | — | — | — | — | 30.0 | 0.7 | 36.9 |

¹The content of the acrylic resin component (solid) in the inks 1 to 3 and 5 to 18 was 9 parts by weight.
²The content of the urethane resin component (solid) in the ink 4 was 9 parts by weight.

(Printing)

An ink bag was filled with the ink 1 and mounted on a JV400-160LX (manufactured by MIMAKI ENGINEERING CO., LTD.) Then the JV400-160LX was used to print a prescribed image (beta image 900×900 dpi, 3×15 cm, and a print ratio of 6.25% (when measuring the dot diameter) or 100% (in a scratch resistance test or an ethanol resistance test)) with the ink 1 on a vinyl chloride medium (PWS-G, manufactured by MIMAKI ENGINEERING CO., LTD.), producing printed matter. The heater temperature during printing was set to 60° C. and the environmental temperature in the periphery of the printer to 25° C. In a similar manner, printed matter was manufactured by printing a prescribed image with the inks 2 to 18. Using this printed matter, the dot diameter was measured, and the scratch resistance test and the ethanol resistance test were carried out.

(Dot Diameter Measurement)

Five dots formed on the printed matter were observed with an optical microscope (VHX-2000, manufactured by Keyence Corporation), and the arithmetic mean of the diameters was found as the dot diameter. The measured dot diameters are shown in Table 2.

TABLE 2

| | Dot diameter |
|---|---|
| | (μm) |
| Ink 1 | 61 |
| Ink 2 | 59 |
| Ink 3 | 54 |

From a comparison of the dot diameters of the inks 1 to 3, it is understood that the dot diameter of the dipropylene glycol monopropyl ether is larger than that of the N-formylmorpholine.

It is inferred that the effects of the N-formylmorpholine and the dipropylene glycol monopropyl ether on the dot diameter act through the surface tension, though it is not desired that the present invention be restricted by this theory. In general, a dot diameter formed by inkjet ink is known to increase in size with a lower ink surface tension. The dipropylene glycol monopropyl ether has a greater capacity than the N-formylmorpholine for reducing the surface tension. It is therefore inferred that the addition of the dipropylene glycol monopropyl ether increases the dot diameter. From this theory, it is thought that adding, to the ink, an optional component for reducing the ink surface tension makes the ink dot diameter larger than when that component is not added.

(Scratch Resistance Test)

Using an oscillation-type friction test machine (RT-300, manufactured by DAIEI KAGAKU SEIKI MFG. CO., LTD.), an image on each sample of the printed matter was rubbed for 10 reciprocations with a friction element that, as the friction material, had a load of 300 gf and that was wrapped with a wrapping film #1000 (manufactured by 3M Company). The ratio of the coating film (image) that had not peeled off the printed matter during the rubbing was evaluated on 10 levels on the basis of the area of the remaining coating film. For example, a scratch resistance of 6 signifies that approximately six-tenths of the coating area that was rubbed did not peel off.

The results of the scratch resistance test are shown in Table 3.

TABLE 3

| | Scratch resistance |
|---|---|
| Ink 1 | 6 |
| Ink 2 | 4 |
| Ink 3 | 6 |
| Ink 4 | 6 |
| Ink 14 | 6 |
| Ink 15 | 6 |

Because the scratch resistance of the ink 1 containing the N-formylmorpholine is superior to the scratch resistance of the ink 2 not containing the N-formylmorpholine, it is understood that the N-formylmorpholine contributes to an improvement in scratch resistance. Because the scratch resistance of the ink 3 not containing the dipropylene glycol monopropyl ether and the scratch resistance of the ink 4 containing the urethane resin in place of the acrylic resin are the same level as the scratch resistance of the ink 1, it is understood that merely adding the N-formylmorpholine improves the scratch resistance regardless of the surface tension and the resin component type.

Similarly, from a comparison of the inks 14 and 15 with the ink 2, it is understood that the 1,3-dimethyl-2-imidazolidinone and the 1-methyl-2-pyrrolidone contribute to an improvement in the scratch resistance.

It is inferred that the penetrability of the N-formylmorpholine, the 1,3-dimethyl-2-imidazolidinone, and the 1-methyl-2-pyrrolidone into the vinyl chloride promotes the penetration of the ink components (in particular the resin component) into the vinyl chloride medium, enhancing the adhesiveness of the ink coating film and the vinyl chloride medium and thereby improving the scratch resistance, though it is not desired that the present invention be restrained by this theory.

The structures of the N-formylmorpholine, the 1,3-dimethyl-2-imidazolidinone, and the 1-methyl-2-pyrrolidone are shown in formulas (a), (b), and (c).

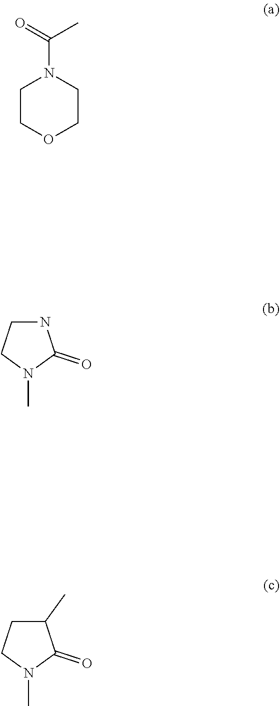

From a comparison of these structures, it is thought that the structure of the nitrogen atom(s) in the heterocycle being adjacent to the carbonyl group (—C(═O)—) contributes to penetrability into the vinyl chloride. Accordingly, a heterocyclic compound having a nitrogen atom in the heterocycle and a carbonyl group adjacent to the nitrogen atom is expected to have penetrability into the vinyl chloride as similar to the N-formylmorpholine, the 1,3-dimethyl-2-imidazolidinone, and the 1-methyl-2-pyrrolidone.

(Ethanol Resistance Test)

Ethanol (99.5%, manufactured by Wako Pure Chemical Industries, Ltd.) was diluted with ion-exchanged water to prepare ethanol of 10%, 20%, 30%, 40%, 50%, 60%, 70%, 80%, and 90%. Then a portion of an image on printed matter was rubbed for 10 reciprocations with a cotton swab that had been dipped in 10% ethanol, and the peeling and fading of the ink coating film were observed. The process was repeated with the ethanol of 20% to 90%. A different portion of the image was rubbed in each process. The maximum ethanol concentration at which the ink coating film did not peel or fade was recorded as the ink ethanol resistance. The results of the ethanol resistance test are shown in Table 4.

TABLE 4

| | Ethanol resistance |
|---|---|
| Ink 1 | 50% |
| Ink 2 | 10% |
| Ink 3 | 40% |
| Ink 4 | 40% |
| Ink 5 | 70% |
| Ink 6 | 60% |
| Ink 7 | 40% |
| Ink 8 | 60% |
| Ink 9 | 70% |
| Ink 10 | 70% |
| Ink 11 | 70% |
| Ink 12 | 70% |
| Ink 13 | 0% |
| Ink 14 | 50% |
| Ink 15 | 70% |
| Ink 16 | 60% |
| Ink 17 | 70% |
| Ink 18 | 70% |

Because the ink 1 containing the N-formylmorpholine has a markedly higher ethanol resistance than the ink 2 with the same composition except for not containing the N-formylmorpholine, it is understood that the N-formylmorpholine improves the ethanol resistance. In particular, because the ink 12, which contains the N-formylmorpholine but not a solvent except for a minute amount in the pigment dispersion liquid, has a markedly higher ethanol resistance than the ink 2 which contains a solvent but not the N-formylmorpholine, it is understood that the N-formylmorpholine improves the ethanol resistance regardless of whether there is a solvent. Because the ink 6 containing 5 parts by weight of the N-formylmorpholine has a markedly higher ethanol resistance than the ink 7 with the same composition except for not containing the N-formylmorpholine, it is understood that even at a low concentration, i.e., 5 parts by weight, the N-formylmorpholine dramatically improves the ethanol resistance. Combining the results of the inks 8 to 11 containing 10 to 50 parts by weight of the N-formylmorpholine with the improvement effect of the N-formylmorpholine on the ethanol resistance peaking at an addition of 20 parts by weight, it is inferred that the improvement effect of the N-formylmorpholine on the ethanol resistance is dependent on or is proportional to the amount of the N-formylmorpholine added up to 20 parts by weight. From this, it is expected that an improvement in the ethanol resistance will be seen according to the amount of N-formylmorpholine added up to less than 5 parts by weight.

Because the ink 1 containing the acrylic resin has a higher ethanol resistance than the ink 4 containing the urethane resin, it is understood that the acrylic resin has superior ethanol resistance compared to the urethane resin.

Because the ink 1 containing the dipropylene glycol monopropyl ether has a higher ethanol resistance than the ink 3 with the same composition other than not containing the dipropylene glycol monopropyl ether, it is thought that the dipropylene glycol monopropyl ether contributes to the ethanol resistance.

The ethanol resistance of the ink 13 being “0%” indicates that the ink 13 did not dry on the base material under the printing conditions and could not be used in the ethanol resistance test because glycerol is used as the solvent in the ink 13.

The ink 14 has the same composition as the ink 1 except for containing the 1,3-dimethyl-2-imidazolidinone in place of the N-formylmorpholine, and the inks 15, 16, 17, and 18 each has the same composition, respectively, as the inks 5, 6, 11, and 12 except for containing the 1-methyl-2-pyrrolidone instead of the N-formylmorpholine. Because the ethanol resistance of the inks 14, 15, 16, 17, and 18 is the same as the ethanol resistance of the inks 1, 5, 6, 11, and 12, the observations of the inks containing the N-formylmorpholine are thought to apply also to the inks containing the 1,3-dimethyl-2-imidazolidinone and the 1-methyl-2-pyrrolidone.

It is inferred that the penetrability of the N-formylmorpholine, the 1,3-dimethyl-2-imidazolidinone, and the 1-methyl-2-pyrrolidone into the vinyl chloride promotes the penetration of the ink components (in particular the resin component) into the vinyl chloride medium, enhancing the adhesiveness of the ink coating film and the vinyl chloride medium and thereby improving the ethanol resistance, though it is not desired that the present invention be restrained by this theory.

(Measurement of the Nozzle Clogging Rate)

An ink bag was filled with the ink 1 and mounted on a JV400-160LX (manufactured by MIMAKI ENGINEERING CO., LTD.) Then, using the JV400-160LX, the ink 1 was ejected on disposable paper from 320 nozzles at five-minute intervals (repeatedly ejecting for three seconds and then pausing for one second). Then, using the JV400-160LX, a test figure pattern (configured from 320 line segments 3 mm wide) loaded in the JV400-160LX was printed with the ink 1 onto a vinyl chloride medium (PSW-G manufactured by MIMAKI ENGINEERING CO., LTD.) The printer head temperature was set to 35° C. and the environmental temperature around the printer to 25° C. during printing on the disposable paper and the base material. The number of line segments without any printing and curved line segments in the printed image was considered to be the number of clogged nozzles, and the nozzle clogging rate was found as a percentage of the number of clogged nozzles to the total number of nozzles. In the same manner, the nozzle clogging rate was found for the inks 2 to 13. The results of the nozzle clogging rates are shown in Table 5.

TABLE 5

| | Nozzle clogging rate |
|---|---|
| Ink 1 | 0% |
| Ink 2 | 0% |
| Ink 3 | 0% |
| Ink 4 | 17% |
| Ink 5 | 0% |
| Ink 6 | 0% |
| Ink 7 | 5% |
| Ink 8 | 0% |
| Ink 9 | 2% |
| Ink 10 | 7% |
| Ink 11 | 43% |
| Ink 12 | 27% |
| Ink 13 | 0% |
| Ink 14 | 0% |
| Ink 15 | 0% |
| Ink 16 | 0% |
| Ink 17 | 43% |
| Ink 18 | 27% |

The ink 13, which is thought to not result in any ink drying or any accompanying nozzle clogging due to the use of glycerol, had a nozzle clogging rate of 0% as predicted. This result confirmed that there was no defect in the printer nozzles when printing began.

Because the ink 1 containing the acrylic resin has a lower nozzle clogging rate than the ink 4 containing the urethane resin, it is understood that the acrylic resin has a superior nozzle clogging rate compared to the urethane resin.

Because the ink 10 containing 30 parts by weight of the N-formylmorpholine and 15 parts by weight of the propylene glycol has a markedly lower nozzle clogging rate than the ink 12 containing 30 parts by weight of the N-formylmorpholine but not a solvent except for a minute amount of solvent in the pigment dispersion liquid, it is understood that a high concentration of the N-formylmorpholine markedly degrades the nozzle clogging rate and that the propylene glycol dramatically alleviates that degradation.

From the results of the inks 1, 3, 6, 6, and 8 to 11 containing various concentrations of the N-formylmorpholine and the propylene glycol, it is understood that by adjusting the amount of propylene glycol, as appropriate, the nozzle clogging rate can be set to within a practical range (e.g., no greater than 10%) and the N-formylmorpholine can be blended up to 30 parts by weight. From the results of the inks 8 to 10, it can be thought that the nozzle clogging rate can be set to within a practical range (e.g., no greater than 10%) by setting the ratio of the weight of the propylene glycol to the N-formylmorpholine (propylene glycol/N-formylmorpholine) to at least 0.5, preferably at least 1.5, and more preferably at least 3. From this, it is expected that even if 50 parts by weight of the N-formylmorpholine are blended, the nozzle clogging rate will be set to within a practical range (e.g., no greater than 10%) if at least 25 parts by weight of the propylene glycol are blended.

From the results of the ink 12 which contains 30 parts by weight of the N-formylmorpholine but does not contain a solvent except for a minute amount of solvent in the pigment dispersion liquid and the ink 13 which contains 10 parts by weight of the N-formylmorpholine and 10 parts by weight of glycerol, it is thought that there is a general proportional relationship between the amount of the N-formylmorpholine added and the nozzle clogging rate in an ink not containing the propylene glycol. Accordingly, it is inferred that the nozzle clogging rate can be set to within a practical range (e.g., no greater than 10%) if the amount of the N-formylmorpholine is kept to no greater than 10 parts by weight, preferably no greater than 5 parts by weight to 100 parts by weight of the ink.

The ink 14 has the same composition as the ink 1 except for containing 1,3-dimethyl-2-imidazolidinone in place of the N-formylmorpholine, and the inks 15, 16, 17, and 18 each has the same compositions, respectively, as the inks 5, 6, 11, and 12 except for containing the 1-methyl-2-pyrrolidone instead of the N-formylmorpholine. Because the nozzle clogging rates of the inks 14, 15, 16, 17, and 18 are the same as the nozzle clogging rates of the inks 1, 5, 6, 11, and 12, the observations of the inks containing the N-formylmorpholine are thought to apply also to the inks containing the 1,3-dimethyl-2-imidazolidinone and the 1-methyl-2-pyrrolidone.

The principle by which the N-formylmorpholine, the 1,3-dimethyl-2-imidazolidinone, and the 1-methyl-2-pyrrolidone degrade the nozzle clogging rate is unclear, but the reason that the propylene glycol improves the dot missing rate can be thought to be that the propylene glycol has a moisturizing effect that prevents the drying and curing of ink inside the nozzle and at the periphery of the nozzle opening. Accordingly, it can be thought that solvents with a moisturizing effect other than the propylene glycol, e.g., a diol solvent, should also improve the nozzle clogging rate. It can be thought that the degradation of the nozzle clogging rate due to the N-formylmorpholine, the 1,3-dimethyl-2-imidazolidinone, and the 1-methyl-2-pyrrolidone can be offset by blending, in a suitable quantity, a solvent having a moisturizing effect in the ink. It is not desired that the present invention be restricted by this theory.

These results are summarized below.

While blending N-formylmorpholine in an inkjet ink improves the scratch resistance and the ethanol resistance, doing so also degrades the nozzle clogging rate.

The degradation of the nozzle clogging rate due to the N-formylmorpholine can be offset by adding a solvent having a moisturizing effect to the ink.

The improving effect of the ethanol resistance by the N-formylmorpholine increases proportionally up until an amount of 20 parts by weight of the N-formylmorpholine to 100 parts by weight of the ink and then peaks, but the degradation of the nozzle clogging rate due to the N-formylmorpholine increases proportionally at least up until the amount of 50 parts by weight of the N-formylmorpholine to 100 parts by weight of the ink. Accordingly, it is inferred that if the adding amount of the N-formylmorpholine is made sufficiently small (e.g., 1 to 10 parts by weight and more preferably 1 to 5 parts by weight to 100 parts by weight of ink), both the ethanol resistance and the nozzle clogging rate can be set to within a practical range (e.g., an ethanol resistance of at least 40% and a nozzle clogging rate of no greater than 10%).

The relationships of the N-formylmorpholine to the scratch resistance, the ethanol resistance, and the nozzle clogging rate can be thought to be applicable to the relationships between the 1,3-dimethyl-2-imidazolidinone or the 1-methyl-2-pyrrolidone and the ethanol resistance and the nozzle clogging rate.

The acrylic resin has a superior ethanol resistance and nozzle clogging rate.

The dipropylene glycol monopropyl ether improves ethanol resistance.

What is claimed is:

1. An inkjet aqueous ink composition comprising a heterocyclic compound having a nitrogen atom in a heterocycle and a carbonyl group adjacent to the nitrogen atom, a resin, and water.

2. The inkjet aqueous ink composition according to claim 1, wherein the heterocyclic compound is selected from the group consisting of 1,3-dimethyl-2-imidazolidinone and 1-methyl-2-pyrrolidone.

3. The inkjet aqueous ink composition according to claim 1, wherein the resin is an acrylic resin.

4. The inkjet aqueous ink composition according to claim 1, further comprising a solvent having a moisturizing effect.

5. The inkjet aqueous ink composition according to claim 4, wherein the solvent having a moisturizing effect is a diol organic solvent.

6. The inkjet aqueous ink composition according to claim 1, further comprising an organic solvent with a boiling point of 250° C. or less.

7. The inkjet aqueous ink composition according to claim 6, wherein the organic solvent with a boiling point of 250° C. or less is a glycol ether organic solvent.
